(19) United States
(12) Patent Application Publication
(10) Pub. No.: US 2025/0305145 A1
(43) Pub. Date: Oct. 2, 2025

(54) METHOD AND DEVICE FOR REPAIRING DAMAGE ON MOUNTING SURFACE OF JOURNAL BOX BODY

(71) Applicant: CRRC QINGDAO SIFANG CO., LTD., Qingdao (CN)

(72) Inventors: Xiaohui HAN, Qingdao (CN); Jinshan CAO, Qingdao (CN); Xiaoguang SUN, Qingdao (CN); Yin MA, Qingdao (CN); Zijing LIU, Qingdao (CN)

(21) Appl. No.: 18/875,616

(22) PCT Filed: Sep. 21, 2023
(86) PCT No.: PCT/CN2023/120345

§ 371 Date: Dec. 16, 2024

(30) Foreign Application Priority Data
Oct. 12, 2022 (CN) 202211248277.7
Nov. 30, 2022 (CN) 202211529888.9

(51) Int. Cl. C23C 24/04; B08B 5/02; B08B 7/00; B08B 7/04; B22F 9/08; C22C 21/10

(52) U.S. Cl. CPC C23C 24/04; B08B 5/02; B08B 7/0042; B08B 7/04; B22F 9/082; C22C 21/10; B22F 2009/0824; B22F 2301/052

(57) ABSTRACT

Disclosed in the present application are a method and device for repairing damage on a mounting surface of a journal box body. The method comprises the following steps: acquiring a size measurement result of a corrosion pit at a damaged position on a mounting surface of a journal box body to determine defect areas of the damaged position, and removing corrosion layers of the defect areas by using subtractive processing treatment; performing classification on the defect areas, and correspondingly spraying the defect areas on the basis of the types of the defect areas to obtain corresponding repair areas; and performing subtractive remanufacturing on each repair area to restore the size of the mounting surface.

### CROSS-REFERENCES TO RELATED APPLICATIONS

The present application is a National Stage of International Application No. PCT/CN2023/120345, filed on Sep. 21, 2023, which claims priority to Chinese patent application No. 202211529888.9, filed on Nov. 30, 2022, entitled “Method for Improving Bonding Strength of High-Pressure Cold Sprayed Coating of Aluminum Alloy”, and Chinese patent application No. 202211248277.7, filed on Oct. 12, 2022, entitled “Method and Device for Repairing Damage on Mounting Surface of Journal Box Body”, and all of which are incorporated herein by reference.

### FIELD

The present application relates to the field of rail transit, and in particular to a method and device for repairing damage on mounting surface of journal box body, and a method for improving bonding strength of high-pressure cold sprayed coating of aluminum alloy component.

### BACKGROUND

Aluminum alloy materials are widely used in transportation, vehicle manufacturing, aerospace, and other fields due to their high specific strength, high specific modulus, and good corrosion resistance. Aluminum alloy materials are important materials for the lightweight of high-speed railways, automobiles, and aircraft. Journal box body is an important component of rail vehicles such as high-speed trains and urban rail subways, and is generally made of aluminum alloy with high strength. Zinc phosphate paint is generally sprayed for protection to prevent galvanic corrosion on the connecting contact surfaces between the journal box body and other components. However, during the operation of the vehicle, the zinc phosphate paint is easily damaged due to fretting wear and environmental factors, resulting in base exposure, thus causing galvanic corrosion on the mounting surface of the journal box body. Various corrosion pits are formed at their surface, causing material loss on the mounting surface of the journal box body made of aluminum alloy, resulting in excessive roughness of the mounting surface that fails to meet the requirements for use, resulting in a high scrap rate for components.

The main measure currently taken to address such issues is to remove the corrosion layer caused by galvanic corrosion on the mounting surface of the journal box body through the means of machining to solve the problem of unqualified roughness. However, the size of the mounting surface of the journal box body has reached the lower limit value after 1 to 2 rounds of machining. If it rusts again, it cannot be repaired by machining and may only be scrapped or sealed for safekeeping. Such operation has the problems of high maintenance costs and a serious waste of resources. However, the commonly used material repair and remanufacturing technologies based on high-energy beams such as laser, plasma, and arc have a series of problems that are currently difficult to overcome when repairing 7-series high-strength aluminum alloys, such as easy cracking of the workpiece, large heat-affected area, and low hardness of the repair layer. Restricted by the processing characteristics of high-strength aluminum alloys, the use of arc surfacing or high-energy laser cladding technology for repair will inevitably cause damage to the substrate structure of the aluminum alloy, resulting in a decrease in the mechanical properties of the area to be repaired and a decrease in accuracy caused by the deformation of precision components due to the heat input.

Currently, cold spraying technology is used to remanufacture and repair the corroded surface of the journal box body. However, the bonding strength of the coating generally could only reach 40 MPa to 60 MPa due to the low bonding strength of ordinary high-pressure cold sprayed coating, which cannot meet the use requirements of high-speed train for high-standard components (in which the bonding strength of the repaired coating must reach more than 100 MPa).

In summary, it is urgent to develop new repair technologies and their corresponding repair process flows.

### BRIEF SUMMARY

The present application provides a method and device for repairing damage on mounting surface of journal box body, which is used to remove the corroded surface of the mounting surface of the journal box body, and on this basis can not only efficiently remove the corrosion products, but also restore the size of the journal box body, which eliminates the influence of a conventional thermal repairing means on the structure state, the size precision, and the mechanical property of parts, and further prolongs the service life of the journal box body.

The present application provides a method for repairing damage on mounting surface of journal box body, including the following steps:
obtaining a size measurement result of a corrosion pit at a damaged position on a mounting surface of a journal box body to determine defect areas of the damaged position, and removing corrosion layers of the defect areas by using subtractive processing treatment;
performing classification on the defect areas, and correspondingly spraying the defect areas respectively based on a type of each of the defect areas to obtain corresponding repair areas; and
performing subtractive remanufacturing on each of the repair areas to restore a size of the mounting surface.

According to the method for repairing damage on mounting surface of journal box body provided by the present application, the step of obtaining the size measurement result of the corrosion pit at the damaged position on the mounting surface of the journal box body to determine defect areas of the damaged position, and removing corrosion layers of the defect areas by using subtractive processing treatment includes the following steps:
determining each of the defect areas of the damaged position based on a position of the corrosion pit, each of the defect areas comprising at least one corrosion pit;
obtaining a maximum depth of the corrosion pit in the same defect area and an area of a corresponding defect area to determine a range for machining processing treatment; and
removing corrosion layers of each of the defect areas by using subtractive processing treatment within each range for machining processing treatment.

According to the method for repairing damage on mounting surface of journal box body provided by the present application, the step of obtaining the maximum depth of the corrosion pit in the same defect area and the area of the corresponding defect area to determine the range for machining processing treatment includes the following steps:
selecting several corrosion pits in the same defect area, measuring a depth of each selected corrosion pit respectively using a depth calibrator, and obtaining the maximum depth of the corrosion pit by comparison;
measuring and calculating the area of the defect area; and
determining the range for machining processing treatment based on the maximum depth of the corrosion pit and the area of the defect area;
where an area of the range for machining processing treatment is larger than the area of the defect area, and a depth of the range for machining processing treatment is not less than the maximum depth of the corrosion pit.

According to the method for repairing damage on mounting surface of journal box body provided by the present application, after the step of removing corrosion layers of each of the defect areas by using subtractive processing treatment within each range for machining processing treatment, the method further includes the following steps:
performing fillet transition process on the defect areas subjected to the subtractive processing treatment;
where an angle between a fillet of the defect area which is subjected to the fillet transition process and a base surface is not greater than 30°.

According to the method for repairing damage on mounting surface of journal box body provided by the present application, the step of performing classification on the defect areas, and correspondingly spraying the defect areas respectively based on the type of each of the defect areas to obtain corresponding repair areas includes the following steps:
obtaining a length and width of each corrosion pit in the defect areas;
performing classification on the defect areas based on the length and width of each corrosion pit to determine types of the defect areas; where the types of defect areas include point defect, line defect, and planar defect;
for the point defect, driving a spray gun to spray perpendicularly to a center of the defect area;
for the linear defect, driving a spray gun to travel along a length direction of the defect area, with a travel path of the spray gun unchanged in a width direction, and determining reciprocating times of the spray gun based on the maximum depth of the corrosion pit; and
for the planar defect, driving a spray gun to travel along a length direction and a width direction of the defect area respectively, and determining reciprocating times of the spray gun based on the maximum depth of the corrosion pit.

According to the method for repairing damage on mounting surface of journal box body provided by the present application, the point defect is a corrosion pit with a length and width both less than 5 mm; the linear defect is a corrosion pit with a length greater than or equal to 5 mm and a width less than or equal to 5 mm; and defects other than the point defect and the linear defect are planar defects.

According to the method for repairing damage on mounting surface of journal box body provided by the present application, before the step of obtaining the size measurement result of the corrosion pit at the damaged position on the mounting surface of the journal box body to determine defect areas of the damaged position, and removing corrosion layers of the defect areas by using subtractive processing treatment, the method further includes the following steps:
performing laser cleaning on the damaged position on the mounting surface; and
performing surface cleaning on the cleaned damaged position to expose the corrosion pit at the damaged position.

According to the method for repairing damage on mounting surface of journal box body provided by the present application, the step of performing laser cleaning on the damaged position on the mounting surface and performing surface cleaning on the cleaned damaged position to expose the corrosion pit at the damaged position includes the following steps:
performing laser cleaning on the damaged position on the mounting surface using a laser cleaning system with a laser power of 50 W to 120 W, for a cleaning time of 2 min to 5 min; and
performing surface cleaning on the cleaned damaged position using a high-pressure air gun, to expose the corrosion pit at the damaged position.

According to the method for repairing damage on mounting surface of journal box body provided by the present application, before the step of performing classification on the defect areas, and correspondingly spraying the defect areas respectively based on the type of each of the defect areas to obtain corresponding repair areas, the method further includes the following steps:
plugging all hole-shaped parts using a plug within the defect areas subjected to the subtractive processing treatment;
sandblasting the defect areas subjected to subtractive processing treatment; and
preheating and spraying the defect areas subjected to sandblasting.

According to the method for repairing damage on mounting surface of journal box body provided by the present application, a surface roughness (Ra) of the defect areas subjected to sandblasting is 5.0 μm to 7.6 μm.

According to the method for repairing damage on mounting surface of journal box body provided by the present application, process parameters of the preheating and spraying include:
using aluminum alloy powder for the preheating and spraying, with a particle size of the powder of 10 μm to 60 μm, a drying temperature of 70±5° C. for the powder, and a preheating and spraying time of 40 min to 60 min;
spraying gas used for preheating and spraying is 99.99% nitrogen;
a gas pressure of the spraying gas is 3.5 MPa to 5.5 MPa;
a spraying distance for the preheating and spraying is 5 mm to 20 mm;
an angle between a spray gun and a spraying surface for the preheating and spraying is not less than 60°.

The present application further provides a device for repairing damage on mounting surface of journal box body, which is capable of executing the method for repairing damage on mounting surface of journal box body as described above.

The device for repairing damage on mounting surface of journal box body includes:
a size measurement system for obtaining a size measurement result of a corrosion pit at a damaged position on a mounting surface of a journal box body;
a subtractive processing treatment system for determining defect areas of the damaged position based on the size measurement result of the corrosion pit, and removing corrosion layers of the defect areas by using subtractive processing treatment;
a spraying system for performing classification on the defect areas, and correspondingly spraying the defect areas respectively based on a type of each of the defect areas to obtain corresponding repair areas; and
a subtractive remanufacturing system for performing subtractive remanufacturing on each of the repair areas to restore a size of the mounting surface.

The present application also provides an aluminum alloy powder for use in the above-mentioned method for repairing damage on mounting surface of journal box body. The aluminum alloy powder includes the following components by weight percentage: 3.2% to 7.8% Zn, 2.0% to 2.7% Mg, 1.5% to 2.9% Cu, 0.02% to 0.06% Ti, 0.3% to 1.5% C, 0.05% to 0.20% Zr, 1.0% to 2.8% Nd, 0.01% to 0.08% Sr, and the balance being Al.

According to an embodiment of the present application, the aluminum alloy powder includes the following components by weight percentage: 1.2% to 2.5% Nd, and/or 0.02% to 0.06% Sr. It has found that Nd and Sr elements within this content range can improve the bonding strength of the coatings and reduce the porosity.

In some specific examples, Nd is contained in an amount of 1.2%, 1.3%, 1.4%, 1.5%, 1.6%, 1.7%, 1.8%, 1.9%, 2.0%, 2.1%, 2.2%, 2.3%, 2.4%, or 2.5%.

In some specific examples, Sr is contained in an amount of 0.02%, 0.03%, 0.04%, 0.05% or 0.06%.

According to an embodiment of the present application, the aluminum alloy powder includes the following components by weight percentage: 2.2% to 2.3% Mg, 5.3% to 6.5% Zn, 1.2% to 2.5% Nd, 0.9% to 1.0% C, 0.12% to 0.15% Zr, 2.0% to 2.2% Cu, 0.03% to 0.04% Ti, 0.02% to 0.06% Sr, and the balance is Al.

According to an embodiment of the present application, the aluminum alloy powder includes the following components by weight percentage: 5.3% Zn, 2.3% Mg, 2.2% Cu, 0.04% Ti, 0.9% C, 0.12% Zr, 1.9% Nd, 0.04% Sr, and the balance is Al.

According to an embodiment of the present application, the particle size of the aluminum alloy powder is 10 μm to 60 μm. In general, a sieve could be used for powder screening. It has found that powders within this particle size range are more uniform and have better fluidity.

According to an embodiment of the present application, the aluminum alloy powder is made by the method of powder atomization, for example, argon atomization.

The present application also provides a method for preparing the above-mentioned aluminum alloy powder, including:
1) mixing ingredients according to element proportions;
2) heating and melting raw materials, and performing atomization to produce powder; and
3) drying and sieving resulting powder to obtain aluminum alloy powder.

The present application further includes the use of the above-mentioned aluminum alloy powder in repair with aluminum alloy materials, especially aluminum alloy materials used in the fields of high-speed railways, automobiles, aircraft, etc. In some specific examples, it is applied to the repair of journal box body of rail vehicles such as high-speed trains or urban rail subways. The journal box body is made of aluminum alloy with high strength, for example, high strength aluminum alloy of 7050FD.

For the engineering practice that the bonding strength of high-pressure cold spraying of aluminum alloy with high strength is low, a method for enhancing the bonding strength of high-pressure cold spraying of aluminum alloy is provided. In this method, high-pressure cold spraying technology can be applied to key aluminum alloy load-bearing components. It not only restores the surface state of aluminum alloy with high strength, but also repairs the strength and function of key components. It plays an important role in promoting the use of high-pressure cold spraying technology in more industrial fields.

The present application also provides a method for improving the bonding strength of high-pressure cold sprayed coating of aluminum alloy, including:
1) sandblasting an area to be repaired;
2) using the aluminum alloy powder as described above for high-pressure cold spraying; and
3) performing solution treatment on a workpiece that has been repaired by spraying.

The aluminum alloy powder of the present application is generally dried before use, for example, dried by placing it in a vacuum drying furnace. In some embodiments, the drying temperature of the vacuum drying furnace is 60° C. to 70° C., and the drying time is 40 min to 60 min. It can be poured into the cold spray powder feeding system for spraying after drying.

According to the embodiment of the present application, the surface of the workpiece to be sprayed is roughened by sandblasting to improve the surface roughness. The spraying process parameters are set according to the depth and area of the repair area. In some embodiments, the surface roughness (Ra) of the workpiece subjected to sandblasting reaches 5.0 μm to 7.6 μm, such as 5.8 μm to 7.6 μm.

According to an embodiment of the present application, the high-pressure cold spraying is performed at a temperature of 350° C. to 500° C., for example, 400° C. to 500° C., under a gas pressure of 4.5 MPa to 5.5 MPa, for example, 5 MPa to 5.5 MPa.

According to an embodiment of the present application, the speed of the high-pressure cold spraying (spray gun) is 250 mm/s to 350 mm/s, for example, 300 mm/s.

According to an embodiment of the present application, the angle of the high-pressure cold spraying (spray gun) is 70° to 90°.

According to an embodiment of the present application, the solution treatment is performed at a temperature of 400° C. to 500° C., for example, 455° C. to 460° C., for the solution treatment time of 30 min to 60 min, for example, 35 min to 40 min.

According to an embodiment of the present application, the high-pressure cold spraying is performed at a temperature of 350° C. to 500° C., under the gas pressure of 4.5 MPa to 5.5 MPa, the speed of the high-pressure cold spraying is 250 mm/s to 350 mm/s, the angle of the high-pressure cold spraying is 70° to 90°, the solution treatment is performed at a temperature of 400° C. to 500° C. for the solution time is 30 min to 60 min. It has found that powder particles may undergo severe plastic deformation when colliding with the base under such preferable conditions, while also causing a corresponding depression on the base surface. Combined with the influence of the surface roughness of the base, excellent bonding quality may be provided between the powder particles and the base. It also reduces or vanishes the hole inside the coating.

The present application performs heat treatment on the cold-sprayed journal box body after high-pressure cold spraying, and the cold-spraying coating achieves extremely high bonding strength and extremely low porosity, solving the problem of low bonding strength and high porosity of ordinary high-pressure cold-sprayed coatings, thereby ensuring the performance of the repaired components.

The method for repairing damage on mounting surface of journal box body provided by the present application innovatively introduces the cold-spraying additive manufacturing technology with the function of deposited metal materials in low-temperature solid-state in the additive (subtractive) remanufacturing technology. Accurate process path design through size measurement and defect classification is provided, to repair damaged parts on the mounting surface of the journal box body with aluminum alloy. Different repair processes are developed for different damage morphologies to solve the problems of high maintenance cost and serious waste of resources in existing aluminum alloy journal box body.

In the method described in the present application, the size of the corrosion pit at the damaged position on the mounting surface of the journal box body is measured, to determine defect areas that can be subjected to subtractive processing treatment, which improves the operation accuracy of removing corrosion layers; finely classification on the defect areas is made and corresponding defect areas are sprayed respectively on the basis of the types of the defect areas according to this method, thereby providing precise spraying. On this basis, subtractive remanufacturing is carried out on each repair area to restore the size of the mounting surface. Compared with the related art, instead of simply machining on a mounting surface of a journal box body to remove the corroded surface, this method repaired corroded defect areas through additive manufacturing by means of high-pressure cold spraying on the basis of subtractive processing. According to the method, corrosion products on the mounting surface of the journal box body can be removed and the size of the journal box body can also be efficiently and accurately restored by performing additive treatment and subtractive treatment in sequence on the basis of removing the corrosion products by machining, which eliminates the influence of a conventional thermal repairing means on the structure state, the size precision, and the mechanical property of parts, and further prolongs the service life of the journal box body.

Furthermore, the method described in the present application could apply high-pressure cold spraying technology to key aluminum alloy load-bearing components. It not only restores the surface state of aluminum alloy with high strength, but also repairs the strength and function of key components. It plays an important role in promoting the use of high-pressure cold spraying technology in more industrial fields.

The present application also provides a device for repairing damage on mounting surface of journal box body. By setting up a size measurement system, a subtractive processing treatment system, a spraying system, and a subtractive remanufacturing system, the device for repairing damage on mounting surface of journal box body is capable of executing the method for repairing damage on mounting surface of journal box body as described above, thereby possessing all the advantages of the method for repairing damage on mounting surface of journal box body as described above. The details are not elaborated here.

The aluminum alloy powder provided in the present application mainly includes elements such as Al, Zn, Mg, Cu, Ti, C, Zr, Nd, and Sr. The present application improves the strength and hardness of powder particles by adding rare earth elements and refining and strengthening the powder, as well as in situ precipitating TiC hard particles inside the powder particles through the addition of Ti and C in alloy elements. During the cold spraying process, particles with higher hardness than the base can be effectively embedded onto the base surface during high-speed impact on the base surface, to allow conventional aluminum alloy powder to form one with higher interfacial bonding strength.

Compared with the existing repair technology by cold spraying, the present application introduces rare earth elements such as Nd and Sr for refining and strengthening by optimizing the powder formula based on the additive manufacturing technology of high-pressure cold spraying. The present application improves the strength and hardness of powder particles by in situ precipitating TiC hard particles inside the powder particles through the addition of Ti and C in alloy elements, achieving a better match with the base strength. During the spraying procedure, a lower spraying temperature is set to avoid excessive softening of the metal particles after heating, and a higher gas pressure is set to impart particles greater kinetic energy; during the deposition procedure, while generating sufficient flattening deformation itself, the compressive stress between particles inside the coating is also enhanced. It is more conducive to the formation of a larger area of nailing interlocking effect at the interface when particles collide with the base, while causing the oxide film on the surface of the powder and base to rupture, thus metallurgical bonding sites are formed under the kinetic energy of particle impact, greatly enhancing the bonding performance. Performing solution heat treatment on the journal box body subjected to spraying and repairing may shrink internal gaps, enhance the diffusion of interface elements, solidify the bonding surface, and further improve bonding strength.

### BRIEF DESCRIPTION OF THE DRAWINGS

To illustrate the solutions in the present application or the related art more clearly, a brief description of the accompanying drawings required for use in the description of the embodiments or the related art is given below. The accompanying drawings described below are some embodiments of the present application. Other drawings may also be obtained based on these accompanying drawings for those skilled in the art without creative labor.

FIG. 1 is a schematic flow chart of a method for repairing damage on mounting surface of journal box body provided in the present application.

FIG. 2 is a morphology diagram of aluminum alloy powder prepared in Embodiment I of the present application.

FIG. 3 is a repaired coating by cold spraying prepared in Embodiment II of the present application.

FIG. 4 is a repaired coating by cold spraying prepared in Comparative Embodiment I of the present application.

### DETAILED DESCRIPTION

To make the objectives, solutions and advantages of the present application clearer, the solutions in the present application are clearly and completely described below in conjunction with the accompanying drawings in the present application. It should be noted that the described embodiments are part of the embodiments of the present application, not all of the embodiments. Based on the embodiments in the present application, all other embodiments obtained by those skilled in the art without creative labor shall fall within the scope of the present application.

The present application is further described below in conjunction with embodiments and Comparative embodiments. The embodiment used herein refers to that the present application includes at least one implementation method, but the present application may also be implemented in other ways different from this embodiment. Therefore, the present application is not limited to the specific embodiments disclosed below.

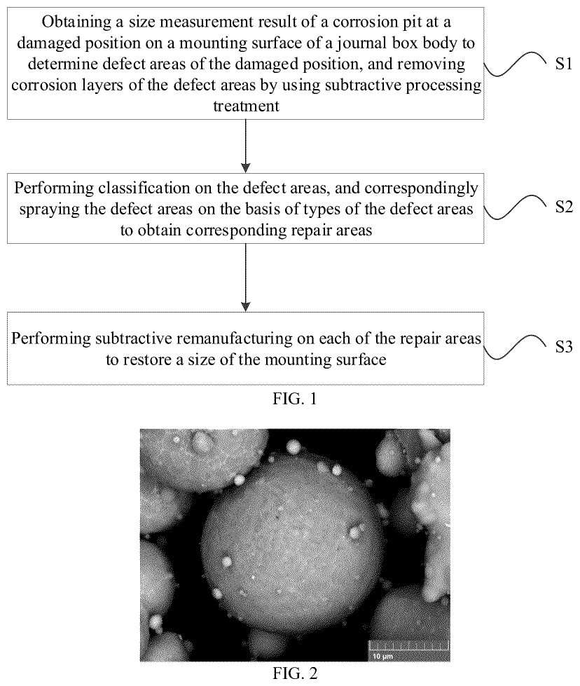

The method for repairing damage on mounting surface of journal box body (referred to “the method” in the present application) and the device for repairing damage on mounting surface of journal box body (referred to “the device” in the present application) are described below in conjunction with FIG. 1.

As shown in FIG. 1, the method for repairing damage on mounting surface of journal box body described in the present application includes the following steps:
S1, obtaining a size measurement result of a corrosion pit at a damaged position on a mounting surface of a journal box body to determine defect areas of the damaged position, and removing corrosion layers of the defect areas by using subtractive processing treatment;
S2, performing classification on the defect areas, and correspondingly spraying the defect areas on the basis of types of the defect areas to obtain corresponding repair areas; and
S3, performing subtractive remanufacturing on each of the repair areas to restore a size of the mounting surface.

In the method described in the present application, in step S1, the size of the corrosion pit at the damaged position on the mounting surface of the journal box body is measured, to determine the defect areas that can be subjected to subtractive processing treatment, which improves the operation accuracy of removing corrosion layers. In step 2, finely classification on the defect areas is performed and corresponding defect areas are sprayed respectively on the basis of the types of the defect areas, to achieve precise spraying. On this basis, in step 3 of the method, subtractive remanufacturing is performed on each of the repair areas to restore the size of the mounting surface. Compared with the related art, instead of simply machining on the mounting surface of the journal box body to remove the corroded surface, the corroded defect areas are repaired in the method through additive manufacturing by the means of high-pressure cold spraying on the basis of subtractive processing. According to the method, corrosion products on the mounting surface of the journal box body can be removed and the size of the journal box body can also be efficiently and accurately restored by performing additive treatment and subtractive treatment in sequence on the basis of removing the corrosion products by machining, which eliminates the influence of a conventional thermal repairing means on the structure state, the size precision and the mechanical property of spare parts, and further prolongs the service life of the journal box body.

In order to ensure that corrosion pits at the damaged position are fully exposed, so that the subsequent size measurement results are more accurate, and to avoid significant differences that may lead to errors in the subsequent determination and classification of defect areas, it is preferred that a surface pretreatment step is included before step S1.

Preferably, the surface pretreatment step may include the following steps:
S01, performing laser cleaning on the damaged position on the mounting surface; and
S02, performing surface cleaning on the cleaned damaged position to expose the corrosion pit at the damaged position.

In order to remove rust and contaminants from the mounting surface of the journal box body and improve the accuracy of subsequent size measurement results and measurement efficiency, it is preferred that step S01 and step S02 described above further include:
S011, performing laser cleaning on the damaged position on the mounting surface using a laser cleaning system with a laser power of 50 W to 120 W, for a cleaning time of 2 min to 5 min; and
S021, performing surface cleaning on the cleaned damaged position using a high-pressure air gun, to expose the corrosion pit at the damaged position.

In step S011, most preferably, the cleaning time is 3 minutes, to ensure that all corrosion pits at the damaged position are completely exposed.

In step S021, a high-pressure air gun is used to perform cleaning on the laser-cleaned surface again after laser cleaning to ensure that no contaminants remain at the damaged position.

In some embodiments, the above step SI further includes the following steps:
S11, determining each of the defect areas of the damaged position based on the position of the corrosion pit, each of the defect areas including at least one corrosion pit;
S12, obtaining a maximum depth of the corrosion pit in the same defect area and an area of a corresponding defect area to determine a range for machining processing treatment; and
S13, removing corrosion layers of each of the defect areas by using subtractive processing treatment within each range for machining processing treatment.

In step S11, several defect areas can be accurately divided at damaged position based on the distribution of corrosion pits, to perform specific process paths and parameter settings for each defect area, to make the division and classification of each defect area at the damaged position more accurate and targeted; then the maximum depth of the corrosion pit and the area of the corresponding defect area are measured and calculated in step S12. Such that contributes to determine the depth and area range of the subtractive processing treatment in the subsequent step S13 and to define an accurate and clear machining processing treatment range, which avoids the subtractive processing being too deep or too large that protects the mounting surface of the journal box body.

In some embodiments, the above step S12 further includes the following steps:
S121, selecting several corrosion pits in the same defect area, and measuring a depth of each selected corrosion pit respectively using a depth calibrator, and obtaining the maximum depth of the corrosion pit by comparison;
S122, measuring and calculating the area of the defect area; and
S123, determining the range for machining processing treatment based on the maximum depth of the corrosion pit and the area of the defect area.

Preferably, the area of the machining processing treatment range is larger than the area of the defect area, and the depth of the machining processing treatment range is not less than the maximum depth of the corrosion pit, which ensures that the range of the subtractive treatment covers the entire defect area and avoid omissions in the operation of removing corrosion layers. It can both reduce the range of the subtractive treatment and improve the accuracy of removing corrosion layer as much as possible.

Preferably, in order to better protect the defect area subjected to the subtractive processing treatment, the following steps are further included preferably after the above-mentioned step S13:
S14, performing fillet transition process on the defect area subjected to the subtractive processing treatment.

The angle between the fillet of the defect area which is subjected to the fillet transition process and the base surface is not greater than 30°. In other words, the method adopts a corrosion pit depth calibrator to detect the depth of the corrosion pit to obtain a corrosion pit with a maximum corrosion depth among several corrosion pits. The depth of the corrosion pit with the maximum corrosion depth is used as the maximum depth of the corrosion pit, and on this basis, 0.2 mm is added to perform subtractive processing on the surface of the corrosion pit. Fillet transition process is applied to the edge part of the machining processing treatment range, which avoids sharp angles or right angles. The angle between the fillet and the base surface is not greater than 30°.

In an embodiment, the steps for measuring the depth of corrosion pits using a corrosion pit depth calibrator are as follows:
placing the mounting surface of the journal box body upwards flatly on a stage;
placing the corrosion pit depth calibrator close to the mounting surface of the journal box body, gently lowering the corrosion pit depth calibrator to make a probe contact a flat surface, adjusting a micrometer to zero, then moving the probe close to an edge of the mounting surface of the journal box body, and adjusting a height of the probe to below a depth to be measured on the mounting surface of the journal box body;
lifting and moving the probe to a top of an area to be measured, then lowering the probe to proceed with measurement;
measuring different parts of the corrosion area randomly, with no less than 5 measuring points, and recording the maximum depth.

Based on the measured maximum depth of the corrosion pits and the area, 0.2 mm is increased on this basis to determine the machining processing treatment. Subtractive processing is performed on the repaired part of the journal box body to remove the corrosion layer, and visually inspect whether the processing depth is sufficient is performed after completion.

In some embodiments, the following steps are preferably included between step S1 and step S2 to better protect the mounting surface of the journal box body during the repairing procedure:
S15, plugging all hole-shaped parts within the defect areas subjected to the subtractive processing treatment using plugs;
S16, sandblasting the defect areas subjected to the subtractive processing treatment;
S17, preheating and spraying the defect areas subjected to sandblasting.

In the preferred step S15, the journal box body to be repaired is preferably mounted on a specialized fixture for ease of operation. It is preferred that use of specialized plugs before sandblasting can provide reliable protection for hole-shaped parts, especially threaded parts, within the defect zone. Preferably, the specialized plug used is non-metallic and does not interfere with the path of spraying particles.

In the preferred step S16, by sandblasting the defect area subjected to the subtractive processing treatment, the sandblasted surface reaches a uniform rough state without metallic luster. Preferably, the surface roughness (Ra) of the defect areas subjected to sandblasting is 5.0 μm to 7.6 μm. Preferably, brown corundum sand with 25 mesh is used for sandblasting, with a sandblasting pressure of 0.3 MPa to 0.6 MPa, a sandblasting distance of 80 mm to 120 mm, a sandblasting angle of 40° to 70°, and a sandblasting time of 2 min to 5 min.

In the preferred step S17, preheating and spraying can preheat the mounting surface to be repaired, thereby drying the powder. Preferably, the process parameters for preheating and spraying may include: using aluminum alloy powder (such as 7050 aluminum alloy powder) for the preheating and spraying, with a particle size of the powder of 10 μm to 60 μm, a drying temperature of 70±5° C. for the powder, and a preheating and spraying time of 40 min to 60 min; the spraying gas used for preheating and spraying is 99.99% nitrogen; the gas pressure of the spraying gas is 3.5 MPa to 5.5 MPa; the spraying distance of the preheating and spraying is 5 mm to 20 mm; the angle between the spray gun and the spraying surface for the preheating and spraying is not less than 60°.

In some embodiments, step S2 further includes the following steps:
S21, obtaining a length and width of each corrosion pit in the defect areas;
S22, performing classification on the defect areas on the basis of the length and width of each corrosion pit to determine the types of the defect areas; where, the types of the defect areas include point defect, line defect and planar defect.

The size of each corrosion pit is accurately obtained through the above-mentioned step S21; the defect areas are accurately classified through the above-mentioned step S22, to develop unique process paths for different types of defect areas, making the cold spraying process more targeted and unique, meeting the process requirements of different areas, and improving the efficiency and quality of the spraying process.

In an embodiment, the above-mentioned step S22 further includes:
for the point defect, driving a spray gun to spray perpendicularly to the center of the defect area, where preferably, the point defect is a corrosion pit with a length and width both less than 5 mm; for the linear defect, driving the spray gun to travel along the length direction of the defect area, with a travel path of the spray gun unchanged in the width direction, and determining the reciprocating times of the spray gun based on the maximum depth of the corrosion pit, where preferably, the linear defect is a corrosion pit with a length greater than or equal to 5 mm and a width less than or equal to 5 mm; for the planar defect, driving the spray gun to travel along the length and width direction of the defect area respectively, and determining the reciprocating times of the spray gun based on the maximum depth of the corrosion pit, where preferably, the defects other than the point defect and the linear defect are planar defects, and the travel distance of the spray gun in the length direction of the defect and the moving distance in the width direction of the defect are set based on the actual area size.

It should be noted that in order to further improve the quality and efficiency of process operations, it is preferred to regard two or more than two point defects with a distance of no more than 5 mm between each other as planar defects, and repair them by spraying according to the spraying process of planar defect; and to regard two or more than two line defects with a distance of no more than 5 mm between each other as planar defects, and repair them by spraying according to the spraying process of planar defect.

In some embodiments, the above-mentioned step S3 further includes: using a milling cutter to process the repair area based on undamaged surface as a processing reference, and restoring related requirements such as surface size and roughness of the repaired area according to the original drawing to ensure the accuracy of the parts.

The device for repairing damage on mounting surface of journal box body provided in the present application is capable of executing the method for repairing damage on mounting surface of journal box body as described above. The device for repairing damage on mounting surface of journal box body includes a size measurement system, a subtractive processing treatment system, a spraying system and a subtractive remanufacturing system. The size measurement system is used to obtain a size measurement result of a corrosion pit at a damaged position on a mounting surface of a journal box body. The subtractive processing treatment system is used to determine defect areas of the damaged position based on the size measurement result of the corrosion pit, and remove corrosion layers of the defect areas by using subtractive processing treatment. The spraying system is used to perform classification on the defect areas, and correspondingly spray the defect areas on the basis of the types of the defect areas to obtain corresponding repair areas. The subtractive remanufacturing system is used to perform subtractive remanufacturing on each of the repair areas to restore the size of the mounting surface.

By setting up a size measurement system, a subtractive processing treatment system, a spraying system and a subtractive remanufacturing system, the device for repairing damage on mounting surface of journal box body is capable of executing the method for repairing damage on mounting surface of journal box body as described above, thereby possessing all the advantages of the method for repairing damage on mounting surface of journal box body as described above. The details are not elaborated here.

The following surface roughness is measured using a surface roughness tester.

### Embodiment I

The Embodiment I provides an aluminum alloy powder, and the preparation method thereof is as follows:
1) 2.3% pure Mg powder, 5.3% pure Zn powder, 1.9% Nd powder, 0.9% graphite powder, 0.12% Zr powder, 2.2% Cu powder, 0.04% Ti powder, 0.04% Sr powder, and the balance being Al powder were selected based on their content by weight percentage, and were put into a vacuum melting furnace; they were powdered by argon atomization at 800° C. after fully melting, and collected after cooling; and
2) a sieve was used for powder screening to obtain aluminum alloy powder with a particle size of 10 μm to 60 μm.

The Embodiment I also provides a method for improving bonding strength of high-pressure cold sprayed coating of aluminum alloy, including:
1) placing the aluminum alloy powder prepared in Embodiment I into a vacuum drying furnace for drying for 40 minutes at a drying temperature of 70° C.;
2) removing the corrosion layer from the surface of the journal box body to be repaired, keeping it dry, and then performing sandblasting, where the surface roughness (Ra) after sandblasting is measured to be 7.6 μm;
the aluminum alloy powder dried in step 1) was used for high-pressure cold spraying, where the air pressure of high-pressure cold spraying was set to 5.0 MPa, the spray gun temperature was set to 400° C., the spray gun speed was set to 300 mm/s, and the spray gun angle was set to 90°; and
3) performing solution heat treatment on the repaired journal box body with a treatment temperature of 455° C. and a holding time of 35 minutes, and cooling it at 60° C.

The micromorphology of the aluminum alloy powder prepared in the Embodiment I under electron microscope is shown in FIG. 2.

The aluminum alloy powder prepared by the method of the Embodiment I plays a role in refining and strengthening through the addition of rare earth elements, which refines the grain size, inhibits grain growth, and improves the mechanical strength of the powder particles. At the same time, the precipitation of TiC hard phase further improves the strength of the powder particles.

In the Embodiment I, the repaired coating was provided by matching reasonable process parameters of cold spraying, and the repaired journal box body was strengthened by solution heat treatment. Finally, the bonding strength test was carried out according to GBT 6396-2008 standard. The coating bonding strength reached 126 MPa with a porosity less than 0.2%.

### Embodiment II

The Embodiment II provides an aluminum alloy powder, and the preparation method thereof is as follows:
1) 2.2% pure Mg powder, 6.5% pure Zn powder, 1.5% Nd powder, 1.0% graphite powder, 0.15% Zr powder, 2.0% Cu powder, 0.03% Ti powder, 0.05% Sr powder, and the balance being Al powder were selected based on their content by weight percentage, and were put into a vacuum melting furnace; they were powdered by argon atomization at 800° C. after fully melting, and collected after cooling; and
2) a sieve was used for powder screening to obtain aluminum alloy powder with a particle size of 15 μm to 55 μm.

The Embodiment II also provides a method for improving the bonding strength of high-pressure cold sprayed coating of aluminum alloy, including:
1) placing the aluminum alloy powder prepared in Embodiment II into a vacuum drying furnace for drying for 1 hour at a drying temperature of 60° C.;
2) removing the corrosion layer from the surface of the journal box body to be repaired, keeping it dry, and then performing sandblasting, where the surface roughness (Ra) after sandblasting is measured to be 5.8 μm;
the aluminum alloy powder dried in step 1) was used for high-pressure cold spraying, where the air pressure of high-pressure cold spraying was set to 5.5 MPa, the spray gun temperature was set to 500° C., the spray gun speed was set to 300 mm/s, and the spray gun angle was set to 70°; and
3) performing solution heat treatment on the repaired journal box body with a treatment temperature of 460° C. and a holding time of 40 minutes, and cooling it at 65° C.

The aluminum alloy powder prepared by the method of the Embodiment II plays a role in refining and strengthening through the addition of rare earth elements, which refines the grain size, inhibits grain growth, generates TiC strengthening phase, and improves the mechanical strength of the powder particles.

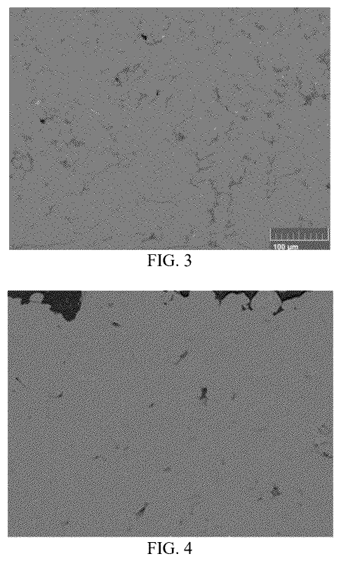

The micromorphology of the internal structure of the cold-spraying repaired coating prepared in the Embodiment II under electron microscope is shown in FIG. 3.

In the Embodiment II, the repaired coating was provided by matching reasonable process parameters of cold spraying, and the bonding strength test was carried out according to GBT 6396-2008 standard. The coating bonding strength reached 130 MPa with a porosity less than 0.2%.

### Embodiment III

The Embodiment III provides an aluminum alloy powder, and the preparation method thereof is as follows:
1) 2.2% pure Mg powder, 6.5% pure Zn powder, 2.5% Nd powder, 1.0% graphite powder, 0.15% Zr powder, 2.0% Cu powder, 0.03% Ti powder, 0.06% Sr powder, and the balance being Al powder were selected based on their content by weight percentage, and were put into a vacuum melting furnace; they were powdered by argon atomization at 800° C. after fully melting, and collected after cooling.
2) a sieve was used for powder screening to obtain aluminum alloy powder with a particle size of 15 μm to 55 μm.

The Embodiment III also provides a method for improving the bonding strength of high-pressure cold sprayed coating of aluminum alloy, including:
1) placing the aluminum alloy powder prepared in Embodiment III into a vacuum drying furnace for drying for 1 hour at a drying temperature of 60° C.;
2) removing the corrosion layer from the surface of the journal box body to be repaired, keeping it dry, and then performing sandblasting, where the surface roughness (Ra) after sandblasting is measured to be 5.8 μm;
the aluminum alloy powder dried in step 1) was used for high-pressure cold spraying, where the air pressure of high-pressure cold spraying was set to 5.5 MPa, the spray gun temperature was set to 500°° C., the spray gun speed was set to 300 mm/s, and the spray gun angle was set to 90°; and
3) performing solution heat treatment on the repaired journal box body with a treatment temperature of 460° C. and a holding time of 40 minutes, and cooling it at 65° C.

The aluminum alloy powder prepared by the method of the Embodiment III plays a role in refining and strengthening through the addition of rare earth elements, which refines the grain size, inhibits grain growth, generates TiC strengthening phase, and improves the mechanical strength of the powder particles.

In the Embodiment III, the repaired coating was prepared by matching reasonable process parameters of cold spraying, and the bonding strength test was carried out according to GBT 6396-2008 standard. The coating bonding strength reached 135 MPa with a porosity less than 0.2%.

### Embodiment IV

The Embodiment IV provides an aluminum alloy powder, and the preparation method thereof is as follows:
1) 2.2% pure Mg powder, 6.5% pure Zn powder, 1.2% Nd powder, 1.0% graphite powder, 0.15% Zr powder, 2.0% Cu powder, 0.03% Ti powder, 0.02% Sr powder, and the balance being Al powder were selected based on their content by weight percentage, and were put into a vacuum melting furnace; they were powdered by argon atomization at 800° C. after fully melting, and collected after cooling; and
2) a sieve was used for powder screening to obtain aluminum alloy powder with a particle size of 15 μm to 55 μm.

The Embodiment IV also provides a method for improving the bonding strength of high-pressure cold sprayed coating of aluminum alloy, including:
1) placing the aluminum alloy powder prepared in Embodiment IV into a vacuum drying furnace for drying for 1 hour at a drying temperature of 60° C.;
2) removing the corrosion layer from the surface of the journal box body to be repaired, keeping it dry, and then performing sandblasting, where the surface roughness (Ra) after sandblasting is measured to be 5.8 μm;
the aluminum alloy powder dried in step 1) was used for high-pressure cold spraying, where the air pressure of high-pressure cold spraying was set to 5.5 MPa, the spray gun temperature was set to 500° C., the spray gun speed was set to 300 mm/s, and the spray gun angle was set to 90°; and
3) performing solution heat treatment on the repaired journal box body with a treatment temperature of 460° C. and a holding time of 40 minutes, and cooling it at 65° C.

The aluminum alloy powder prepared by the method of the Embodiment IV plays a role in refining and strengthening through the addition of rare earth elements, which refines the grain size, inhibits grain growth, generates TiC strengthening phase, and improves the mechanical strength of the powder particles.

In the Embodiment IV, the repaired coating was prepared by matching reasonable process parameters of cold spraying, and the bonding strength test was carried out according to GBT 6396-2008 standard. The coating bonding strength reached 125 MPa with a porosity less than 0.2%.

### Comparative Embodiment I

The comparative Embodiment I provides an aluminum alloy powder, and the preparation method thereof is as follows:
1) 2.2% pure Mg powder, 6.5% pure Zn powder, 1.0% graphite powder, 0.15% Zr powder, 2.0% Cu powder, 0.03% Ti powder, and the balance being Al powder were selected based on their content by weight percentage, and were put into a vacuum melting furnace; they were powdered by argon atomization at 800°° C. after fully melting, and collected after cooling; and
2) a sieve was used for powder screening to obtain aluminum alloy powder with a particle size of 15 μm to 55 μm.

The comparative Embodiment I also provides a method for improving the bonding strength of high-pressure cold sprayed coating of aluminum alloy, including:
1) placing the aluminum alloy powder prepared in comparative Embodiment I into a vacuum drying furnace for drying for 1 hour at a drying temperature of 60° C.;
2) removing the corrosion layer from the surface of the journal box body to be repaired, keeping it dry, and then performing sandblasting, where the surface roughness (Ra) after sandblasting is measured to be 5.8 μm;
the aluminum alloy powder dried in step 1) was used for high-pressure cold spraying, where the air pressure of high-pressure cold spraying was set to 3.5 MPa, the spray gun temperature was set to 500° C., the spray gun speed was set to 300 mm/s, and the spray gun angle was set to 70°.

The micromorphology of the cold-spraying repaired coating prepared in the comparative Embodiment I under electron microscope is shown in FIG. 4.

The aluminum alloy powder prepared in the comparative Embodiment I has no addition of rare earth elements, thus the powder particles are not sufficiently strengthened. There is no hard phase generated, thus it is difficult to match the base strength. Therefore, a large amount of pinning and anchoring effect cannot be formed at the base interface. In addition, sufficient compressive stress is not generated inside the coating due to the use of a lower gas pressure of spraying. No solution heat treatment is performed after spraying, resulting in a high porosity. The bonding strength test was carried out according to GBT 6396-2008 standard, and the coating bonding strength was only 48 MPa with a porosity of 0.8%.

### Comparative Embodiment II

The comparative Embodiment II provides a method for improving the bonding strength of high-pressure cold sprayed coating of aluminum alloy, including:
1) placing the aluminum alloy powder prepared in Embodiment II into a vacuum drying furnace for drying for 1 hour at a drying temperature of 70° C.;
2) removing the corrosion layer from the surface of the journal box body to be repaired, keeping it dry, and then performing sandblasting, where the surface roughness (Ra) after sandblasting is measured to be 5.8 μm;
the aluminum alloy powder dried in step 1) was used for high-pressure cold spraying, where the air pressure of high-pressure cold spraying was set to 3.5 MPa, the spray gun temperature was set to 500° C., the spray gun speed was set to 300 mm/s, and the spray gun angle was set to 70°; and
3) performing heat treatment on the repaired journal box body with a solution treatment temperature of 460° C. and a holding time of 40 minutes, and cooling it at 65° C.

A lower gas pressure of spraying was employed in the comparative Embodiment II, and it has limited acceleration effect on powder particles. The degree of plastic deformation of particles is moderate. Sufficient compressive stress is not generated inside the coating, resulting in a high porosity. The bonding strength test was carried out according to GBT 6396-2008 standard, and the coating bonding strength was only 47 MPa with a porosity of 1.2%.

### Comparative Embodiment III

The comparative Embodiment III provides a method for improving the bonding strength of high-pressure cold sprayed coating of aluminum alloy, including:
1) placing the aluminum alloy powder prepared in Embodiment II into a vacuum drying furnace for drying for 1 hour at a drying temperature of 70° C.;
2) removing the corrosion layer from the surface of the journal box body to be repaired, keeping it dry, and then performing sandblasting, where the surface roughness (Ra) after sandblasting is measured to be 5.8 μm;
the aluminum alloy powder dried in step 1) was used for high-pressure cold spraying, where the air pressure of high-pressure cold spraying was set to 5.5 MPa, the spray gun temperature was set to 500° C., the spray gun speed was set to 300 mm/s, and the spray gun angle was set to 70°;

A higher gas pressure of spraying was employed in the comparative Embodiment III, but no solution strengthening after spraying was performed, which failed to further eliminate internal defects, strengthen interface element diffusion, and solidify the bonding surface. The bonding strength test was carried out according to GBT 6396-2008 standard, and the coating bonding strength was 89 MPa with a porosity of 0.8%.

### Comparative Embodiment IV

The comparative Embodiment IV provides an aluminum alloy powder, and the preparation method thereof is as follows:
1) 2.3% pure Mg powder, 5.3% pure Zn powder, 0.9% Nd powder, 0.9% graphite powder, 0.12% Zr powder, 2.2% Cu powder, 0.04% Ti powder, 0.01% Sr powder, and the balance being Al powder were selected based on their content by weight percentage, and were put into a vacuum melting furnace; they were powdered by argon atomization at 800° C. after fully melting, and collected after cooling; and
2) a sieve was used for powder screening to obtain aluminum alloy powder with a particle size of 15 μm to 55 μm.

The aluminum alloy powder prepared in the comparative Embodiment IV was used to repair the journal box body in the same manner as in Embodiment I. In the aluminum alloy powder prepared in the comparative Embodiment IV, the addition amounts of Nd and Sr elements were reduced, and the hardening effect of the powder was affected. The bonding strength test was carried out according to GBT 6396-2008 standard, and the coating bonding strength was 103 MPa with a porosity of 0.3%.

### Comparative Embodiment V

The comparative Embodiment V provides an aluminum alloy powder, and the preparation method thereof is as follows:
1) 2.3% pure Mg powder, 5.3% pure Zn powder, 3.0% Nd powder, 0.9% graphite powder, 0.12% Zr powder, 2.2% Cu powder, 0.04% Ti powder, 0.1% Sr powder, and the balance being Al powder were selected based on their content by weight percentage, and were put into a vacuum melting furnace; they were powdered by argon atomization at 800° C. after fully melting, and collected after cooling; and
2) a sieve was used for powder screening to obtain aluminum alloy powder with a particle size of 15 μm to 55 μm.

The aluminum alloy powder prepared in the comparative Embodiment V was used to repair the journal box body in the same manner as in Embodiment I. In the aluminum alloy powder prepared in the comparative Embodiment V, the addition amounts of Nd and Sr elements were increased, which was prone to powder inclusions, increased porosity, and loose internal structure of the coating. The bonding strength test was carried out according to GBT 6396-2008 standard, and the coating bonding strength was 92 MPa with a porosity of 0.7%.

In the description of the embodiments of the present application, it should be noted that the directional or positional relationships indicated by terms such as “center”, “longitudinal”, “lateral”, “up”, “down”, “front”, “back”, “left”, “right”, “vertical”, “horizontal”, “top”, “bottom”, “inside”, “outside”, are based on the orientations or positional relationships shown in the accompanying drawings, and are only for the convenience of describing the embodiments of the present application and simplifying the description, and do not indicate or imply that the device or element referred to must have a specific orientation, be constructed and operated in a specific orientation, and therefore should not be understood as limitations on the embodiments of the present application. Furthermore, the terms “first”, “second”, and “third” are only used for descriptive purposes and should not be understood as indicating or implying relative importance.

In the description of the embodiments of the present application, it should be noted that, the terms “connect” and “connected” should be understood in a broad sense, unless otherwise clearly stated and specified. For example, it can be a fixed connection, a detachable connection, or an integral connection; it can be a mechanical connection or an electrical connection; it can be a direct connection or an indirect connection through an intermediate medium. For those skilled in the art, the specific meanings of the above terms in the embodiments of the present application can be understood according to specific circumstances.

In the embodiments of the present application, a first feature being “on” or “under” a second feature may refer to that the first and second features are in direct contact, or the first and second features are in indirect contact through an intermediate medium, unless otherwise clearly stated and specified. Moreover, a first feature being “on”, “above” and “on the top of” a second feature may refer to that the first feature is directly on or obliquely on the second feature, or simply refer to that the first feature is horizontally higher than the second feature. A first feature being “under”, “below” and “beneath” a second feature may refer to that the first feature is directly under or obliquely under the second feature, or simply refer to that the first feature is horizontally lower than the second feature.

In the description of this specification, the description with reference to terms such as “one embodiment”, “some embodiments”, “example”, “specific example”, or “some embodiments” are intended to mean that the specific features, structures, materials or characteristics described in conjunction with the embodiment or example are included in at least one embodiment or example of the embodiments of the present application. In the present description, the exemplary expressions of the above terms do not necessarily refer to the same embodiment or example.

Furthermore, the specific features, structures, materials, or characteristics described may be combined in any proper manner in any one or more embodiments or examples. Furthermore, those skilled in the art may combine and associate different embodiments or examples with features of different embodiments or examples described in the present description without mutual contradiction.

Although the present application has been described in detail with general explanations and specific implementation schemes, it is obvious to those skilled in the art that some modifications or improvements can be made to the present application.

Finally, it should be noted that the above embodiments are only used to illustrate the solutions of the present application, rather than to limit the present application. Although the present application has been described in detail with reference to the aforementioned embodiments, those skilled in the art should understand that they can still modify the solutions described in the aforementioned embodiments, or make equivalent substitutions for some of the features therein. However, these modifications or substitutions do not depart the essence of the corresponding solutions from the scope of the solutions of the embodiments of the present application.

1. A method for repairing damage on mounting surface of journal box body, comprising the following steps:
obtaining a size measurement result of a corrosion pit at a damaged position on a mounting surface of a journal box body to determine defect areas of the damaged position, and removing corrosion layers of the defect areas by using subtractive processing treatment;
performing classification on the defect areas, and correspondingly spraying the defect areas respectively based on a type of each of the defect areas to obtain corresponding repair areas; and
performing subtractive remanufacturing on each of the repair areas to restore a size of the mounting surface.

2. The method for repairing damage on mounting surface of journal box body according to claim 1, wherein the step of obtaining the size measurement result of the corrosion pit at the damaged position on the mounting surface of the journal box body to determine defect areas of the damaged position, and removing corrosion layers of the defect areas by using subtractive processing treatment comprises the following steps:
determining each of the defect areas of the damaged position based on a position of the corrosion pit, each of the defect areas comprising at least one corrosion pit;
obtaining a maximum depth of the corrosion pit in the same defect area and an area of a corresponding defect area to determine a range for machining processing treatment; and
removing corrosion layers of each of the defect areas by using subtractive processing treatment within each range for machining processing treatment.

3. The method for repairing damage on mounting surface of journal box body according to claim 2, wherein the step of obtaining the maximum depth of the corrosion pit in the same defect area and the area of the corresponding defect area to determine the range for machining processing treatment comprises the following steps:
selecting several corrosion pits in the same defect area, and measuring a depth of each selected corrosion pit respectively using a depth calibrator, and obtaining the maximum depth of the corrosion pit by comparison;
measuring and calculating the area of the defect area; and
determining the range for machining processing treatment based on the maximum depth of the corrosion pit and the area of the defect area;
wherein an area of the range for machining processing treatment is larger than the area of the defect area, and a depth of the range for machining processing treatment is not less than the maximum depth of the corrosion pit.

4. The method for repairing damage on mounting surface of journal box body according to claim 2, wherein after the step of removing corrosion layers of each of the defect areas by using subtractive processing treatment within each range for machining processing treatment, the method further comprises the following steps:
performing fillet transition process on the defect areas subjected to the subtractive processing treatment;
wherein an angle between a fillet of the defect area which is subjected to the fillet transition process and a base surface is not greater than 30°.

5. The method for repairing damage on mounting surface of journal box body according to claim 2, wherein the step of performing classification on the defect areas, and correspondingly spraying the defect areas respectively based on the type of each of the defect areas to obtain corresponding repair areas comprises the following steps:
obtaining a length and a width of each corrosion pit in the defect areas;
performing classification on the defect areas based on the length and width of each corrosion pit to determine types of the defect areas; wherein the types of the defect areas comprise point defect, line defect and planar defect;
for the point defect, driving a spray gun to spray perpendicularly to a center of the defect area;
for the linear defect, driving a spray gun to travel along a length direction of the defect area, with a travel path of the spray gun unchanged in a width direction, and determining reciprocating times of the spray gun based on the maximum depth of the corrosion pit; and
for the planar defect, driving a spray gun to travel along a length direction and a width direction of the defect area respectively, and determining reciprocating times of the spray gun based on the maximum depth of the corrosion pit.

6. The method for repairing damage on mounting surface of journal box body according to claim 5, wherein the point defect is a corrosion pit with a length and width both less than 5 mm; the linear defect is a corrosion pit with a length greater than or equal to 5 mm and a width less than or equal to 5 mm; and defects other than the point defect and the linear defect are planar defects.

7. The method for repairing damage on mounting surface of journal box body according to claim 1, wherein before the step of obtaining the size measurement result of the corrosion pit at the damaged position on the mounting surface of the journal box body to determine defect areas of the damaged position, and removing corrosion layers of the defect areas by using subtractive processing treatment, the method further comprises the following steps:
performing laser cleaning on the damaged position on the mounting surface; and
performing surface cleaning on the cleaned damaged position to expose the corrosion pit at the damaged position.

8. The method for repairing damage on mounting surface of journal box body according to claim 7, wherein the step of performing laser cleaning on the damaged position on the mounting surface and performing surface cleaning on the cleaned damaged position to expose the corrosion pit at the damaged position comprises the following steps:
performing laser cleaning on the damaged position on the mounting surface using a laser cleaning system with a laser power of 50 W to 120 W, for a cleaning time of 2 min to 5 min; and
performing surface cleaning on the cleaned damaged position using a high-pressure air gun, to expose the corrosion pit at the damaged position.

9. The method for repairing damage on mounting surface of journal box body according to claim 1, wherein before the step of performing classification on the defect areas, and correspondingly spraying the defect areas respectively based on the type of each of the defect areas to obtain corresponding repair areas, the method further comprises the following steps:
plugging all hole-shaped parts using a plug within the defect areas subjected to the subtractive processing treatment;
sandblasting the defect areas subjected to the subtractive processing treatment; and
preheating and spraying the defect areas subjected to sandblasting.

10. The method for repairing damage on mounting surface of journal box body according to claim 9, wherein a surface roughness (Ra) of the defect areas subjected to sandblasting is 5.0 μm to 7.6 μm.

11. The method for repairing damage on mounting surface of journal box body according to claim 9, wherein process parameters of the preheating and spraying comprise:
using aluminum alloy powder for the preheating and spraying, with a particle size of the powder of 10 μm to 60 μm, a drying temperature of 70±5° C. for the powder, and a preheating and spraying time of 40 min to 60 min;
spraying gas used for preheating and spraying is 99.99% nitrogen;
a gas pressure of the spraying gas is 3.5 MPa to 5.5 MPa;
a spraying distance for the preheating and spraying is 5 mm to 20 mm;
an angle between a spray gun and a spraying surface for the preheating and spraying is not less than 60°.

12. A device for repairing damage on mounting surface of journal box body, which is capable of executing the method for repairing damage on mounting surface of journal box body as claimed in claim 1;
the device for repairing damage on mounting surface of journal box body comprises:
a size measurement system for obtaining a size measurement result of a corrosion pit at a damaged position on a mounting surface of a journal box body;
a subtractive processing treatment system for determining defect areas of the damaged position based on the size measurement result of the corrosion pit, and removing corrosion layers of the defect areas by using subtractive processing treatment;
a spraying system for performing classification on the defect areas, and correspondingly spraying the defect areas respectively based on a type of each of the defect areas to obtain corresponding repair areas; and
a subtractive remanufacturing system for performing subtractive remanufacturing on each of the repair areas to restore a size of the mounting surface.

13. An aluminum alloy powder for use in the method for repairing damage on mounting surface of journal box body of claim 11, comprising the following components by weight percentage: 3.2% to 7.8% Zn, 2.0% to 2.7% Mg, 1.5% to 2.9% Cu, 0.02% to 0.06% Ti, 0.3% to 1.5% C, 0.05% to 0.20% Zr, 1.0% to 2.8% Nd, 0.01% to 0.08% Sr, and the balance being Al.

14. The aluminum alloy powder of claim 13, wherein the aluminum alloy powder comprises the following components by weight percentage: 1.2% to 2.5% Nd, and/or 0.02% to 0.06% Sr;
preferably, the aluminum alloy powder comprises the following components by weight percentage: 2.2% to 2.3% Mg, 5.3% to 6.5% Zn, 1.2% to 2.5% Nd, 0.9% to 1.0% C, 0.12% to 0.15% Zr, 2.0% to 2.2% Cu, 0.03% to 0.04% Ti, 0.02% to 0.06% Sr, and the balance being Al.

15. A method for preparing the aluminum alloy powder of claim 13, comprising:
1) mixing ingredients according to element proportions;
2) heating and melting raw materials, and performing atomization to produce powder; and
3) drying and sieving resulting powder to obtain aluminum alloy powder.

16. The method for preparing the aluminum alloy powder of claim 15, wherein the atomization for powder production adopts argon atomization.

17. Aluminum alloy powder prepared by the method of claim 15.

18. Use of the aluminum alloy powder of claim 13 in repair with aluminum alloy materials.

19. A method for improving bonding strength of high-pressure cold sprayed coating of aluminum alloy, comprising:
1) sandblasting an area to be repaired, wherein a surface roughness (Ra) of the workpiece subjected to sandblasting is 5.0 μm to 7.6 μm, preferably 5.8 μm to 7.6 μm;
2) using the aluminum alloy powder of claim 13 for high-pressure cold spraying; and
3) performing solution treatment on a workpiece that has been repaired by spraying.

20. (canceled)

21. The method of claim 19, wherein the high-pressure cold spraying is performed at a temperature of 350° C. to 500° C. under a gas pressure of 4.5 MPa to 5.5 MPa; and/or the solution treatment is performed at a temperature of 400° C. to 500° C. for a solution treatment time of 30 min to 60 min.
